(19) United States
(12) Patent Application Publication
(10) Pub. No.: US 2020/0310735 A1
(43) Pub. Date: Oct. 1, 2020

(54) MODULAR DISPLAY UNIT AND METHOD OF DISPLAYING AND CONTROLLING CABIN FUNCTIONS

(71) Applicant: MITSUBISHI HEAVY INDUSTRIES, LTD., Tokyo (JP)

(72) Inventors: Sasha Dean-Bhïyan, Aichi (JP); Victor-Daniel Gheorghian, Aichi (JP); Renato Seiji Morita, Aichi (JP)

(73) Assignee: MITSUBISHI HEAVY INDUSTRIES, LTD., Tokyo (JP)

(21) Appl. No.: 16/503,271

(22) Filed: Jul. 3, 2019

Related U.S. Application Data
(60) Provisional application No. 62/826,197, filed on Mar. 29, 2019.
(60) Provisional application No. 62/826,207, filed on Mar. 29, 2019.
(60) Provisional application No. 62/826,219, filed on Mar. 29, 2019.

(51) Int. Cl. G06F 3/14; G06F 3/0488; G06F 3/0481; G09G 5/10; G06F 3/01; G06F 3/16; B64D 11/00

(52) U.S. Cl. CPC G06F 3/1423; G06F 3/0488; G06F 3/04817; G09G 5/10; G06F 3/011; G06F 3/16; G09G 2320/0693; B64D 11/00155; G09G 2360/144; G09G 2370/022; G09G 2370/16; G09G 2380/12; G09G 2354/00; B64D 11/00152

(57) ABSTRACT

An aircraft cabin system includes: a cabin server that stores an application and a graphical attribute; and a plurality of modular displays connected to the cabin server via a network. Each of the modular displays includes: a modular display dock hardwired to the network; and a modular display body that is detachably attached and electrically connected to the modular display dock. The modular display body includes: a touch screen that displays a GUI; and a processor. The processor sends, to the cabin server, a request for the application and the graphical attribute when the modular display body is coupled to the modular display dock, the cabin server sends, to the modular display body via the modular display dock, the application and the graphical attribute in response to the request.

### BACKGROUND

### Technical Field

The present invention generally relates to a display unit that displays and controls cabin functions, and a cabin system that centrally manages and controls the display units.

### Description of Related Art

As should be apparent to airplane travelers, a Passenger Service Unit (PSU) in an aircraft contains, among other things, reading lights, loudspeakers, illuminated signs, air vents, and oxygen masks. As shown in FIG. 1, the PSU installed above each passenger seat contains a speaker, fasten-seat-belt (FSB) sign, switches accessible by the passenger to control individual reading lights, flight attendant call switch, etc. This basic operational approach has been employed by airlines and aircraft Original Equipment Manufacturers (OEMs) for many years.

As shown in FIG. 2, each component of the PSU interfaces independently to an aircraft cabin system to transmit/receive power and data. Each control system operates independently from one another, thereby requiring separate wiring interfaces between each component and the aircraft system.

Meanwhile, some conventional portable media devices integrate video, audio, and content selection systems. Such conventional devices provide media contents but may not display cabin functions such as cabin information signs or control cabin functions such as turning on/off reading lights, calling a flight attendant, etc.

Further, some conventional personal portable control devices may provide media contents but do not contain embedded speaker and light, and may not output passenger address (PA) audio, or may not display or control cabin functions.

### SUMMARY

One or more embodiments of the present invention provide a modular display unit (MDU or “modular display”) that displays and controls cabin functions, and a system that centrally manages and controls a plurality of MDUs.

One or more embodiments provide an aircraft cabin system comprising: a cabin server that stores an application and a graphical attribute; and a plurality of modular displays connected to the cabin server via a network, wherein each of the modular displays comprises: a modular display dock hardwired to the network; and a modular display body that is detachably attached and electrically connected to the modular display dock, the modular display body comprises: a touch screen that displays a GUI; and a processor, the processor sends, to the cabin server, a request for the application and the graphical attribute when the modular display body is coupled to the modular display dock, the cabin server sends, to the modular display body via the modular display dock, the application and the graphical attribute in response to the request, and upon receiving the application and the graphical attribute, the processor performs a user controllable function in response to an operation of the touch screen, and performs a user non-controllable function via the modular display body, according to the application and the graphical attribute.

### BRIEF DESCRIPTION OF DRAWINGS

FIG. 1 shows a diagram illustrating a structure of a conventional Passenger Service Unit (PSU).

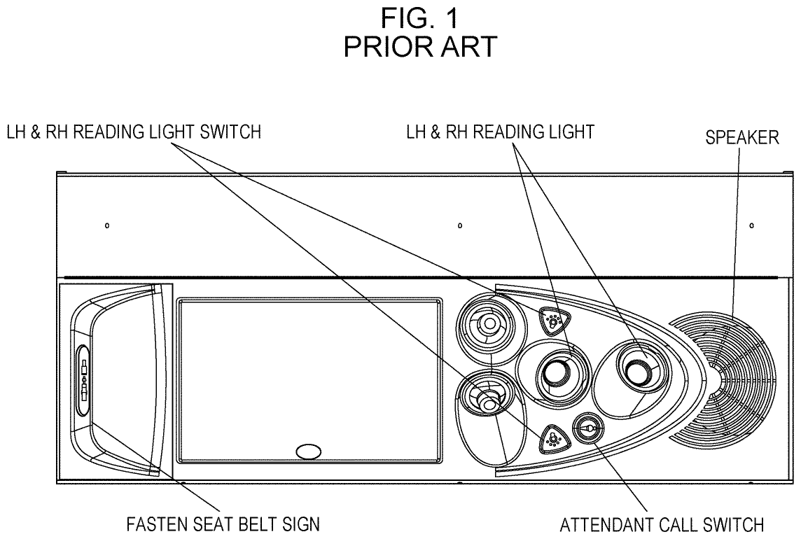

FIG. 2 shows a block diagram of the PSU.

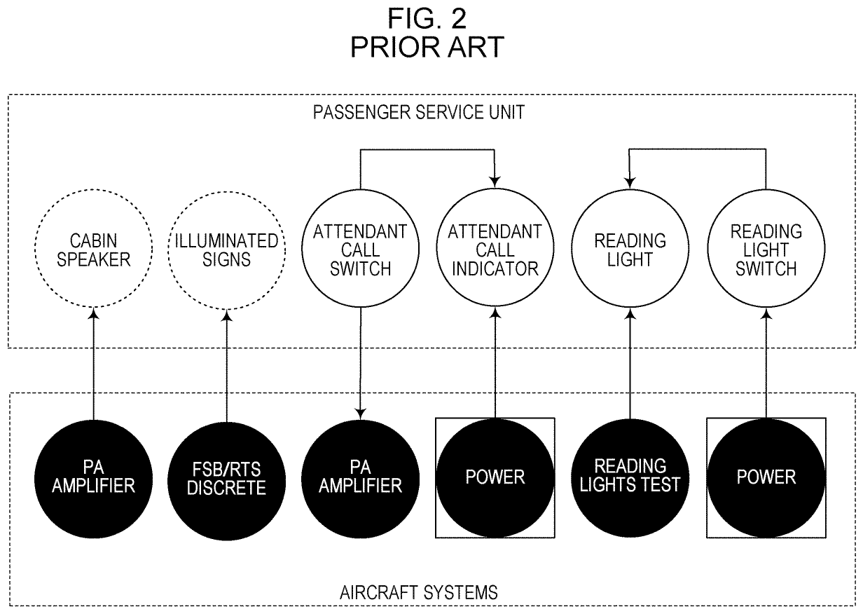

FIG. 3 shows a schematic view of an aircraft cabin system according to one or more embodiments.

FIG. 4 shows a diagram of an overall architecture of the aircraft cabin system according to one or more embodiments.

FIG. 5 shows a block diagram of the aircraft cabin system according to one or more embodiments.

FIG. 6A shows a diagram illustrating arrangement of other MDU variants according to one or more embodiments.

FIG. 6B shows a schematic view of an aircraft cabin system equipped with other MDU variants according to one or more embodiments.

FIG. 7 shows a block diagram of functional components of a cabin head end unit (HEU) according to one or more embodiments.

FIG. 8 shows a block diagram of functional components of a modular display unit (MDU) according to one or more embodiments.

FIG. 9 shows a table illustrating correspondence between subparts of the MDU body and software applications installable on the MDU body according to one or more embodiments.

FIG. 10 shows a diagram illustrating a Graphical User Interface (GUI) with icons appearing on an MDU screen corresponding to the software applications installed on the MDU body according to one or more embodiments.

FIG. 11 shows a diagram explaining a conceptual scheme of common and different functions of the MDUs at different locations within an aircraft cabin according to one or more embodiments.

FIG. 12 shows the MDU body according to one or more embodiments.

FIG. 13 shows the MDU body together with an MDU dock according to one or more embodiments.

FIG. 14 shows a diagram illustrating another example of the MDUs according to one or more embodiments.

FIG. 15 shows a block diagram of functional components of a cabin management system (CMS) terminal according to one or more embodiments.

FIG. 16 shows a table illustrating correspondence between subparts of the CMS body and software applications installable on the CMS body according to one or more embodiments.

FIG. 17 shows a block diagram of functional components of other MDU variants according to one or more embodiments.

FIG. 18 shows a table illustrating correspondence between subparts of a MDU body of other MDU variants and software applications installable on the MDU body of other MDU variants according to one or more embodiments.

FIG. 19 shows a flowchart of management and control processing of the MDUs according to one or more embodiments.

### DETAILED DESCRIPTION

Embodiments of the present invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

One or more embodiments of the present invention are directed to a modular display unit (MDU, or modular display) that displays and controls cabin functions, and a cabin system that centrally manages and controls a plurality of MDUs. A cabin function may include turning on/off and dimming embedded reading lights, outputting passenger address (PA) audio via embedded speakers, calling a flight attendant, indicating cabin information signs, and other functions that provide a service to passengers and/or flight attendants, henceforth identified as users, in an aircraft cabin.

As will become apparent from the following description, one or more embodiments of the invention effectively integrate multiple hardware components into a single device (MDU), thereby reducing the number of hardware components and wiring in the cabin system, as well as the volume required for installation and integration of such components. By reducing the number of components and wiring complexity, one or more embodiments of the invention also reduce the overall weight throughout the cabin system and improve overall reliability of the cabin system during operation (due to fewer potential failure points). Compared to conventional systems, one or more embodiments of the invention are also easily configurable for multiple purposes and provide improved modularity, which in turn improves flexibility and reduces maintenance and installation time as well as maintenance and installation cost. Other advantages will be appreciated and understood from the below description and examples of the invention.

[Cabin System]

A cabin system according to one or more embodiments comprises an integrated cabin system (ICS) comprising hardware and software components constituting baseline and optional cabin electronics framework on an aircraft.

The cabin system may be employed on any aircraft (e.g., commercial airplanes, business jets, etc.). The cabin system can also be employed in any other suitable environment such as a train and a ship, but for purposes of illustration the embodiments are described with respect to an aircraft.

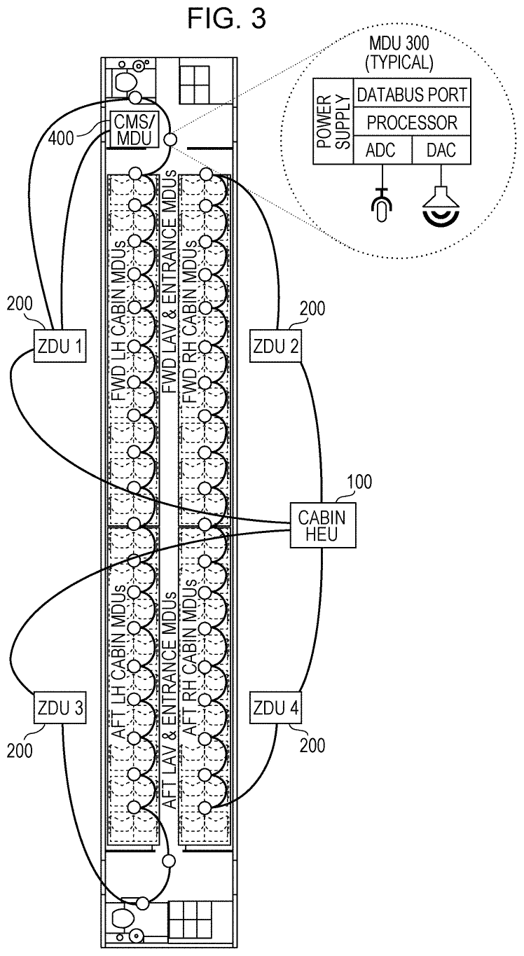

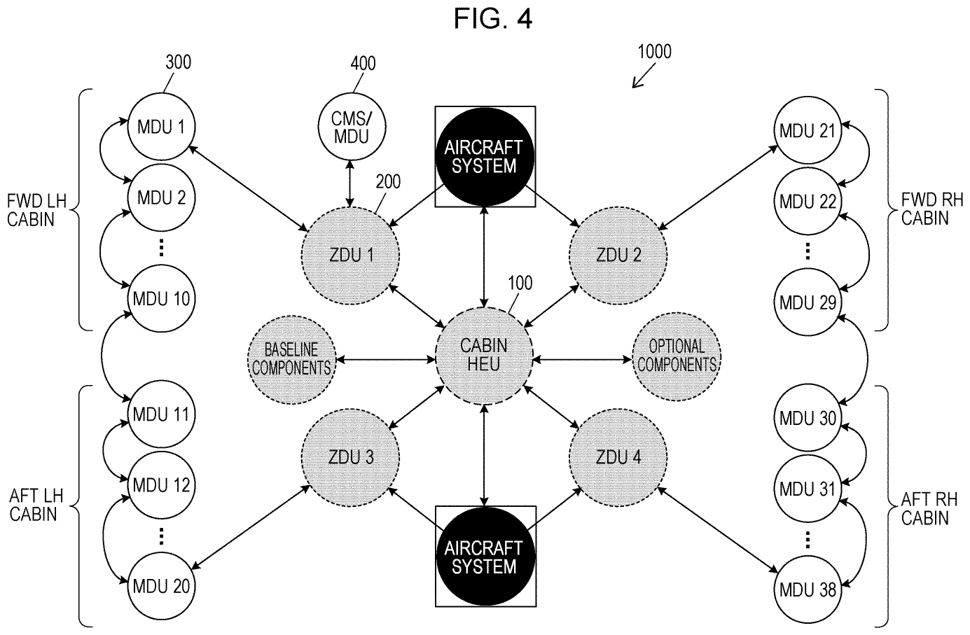

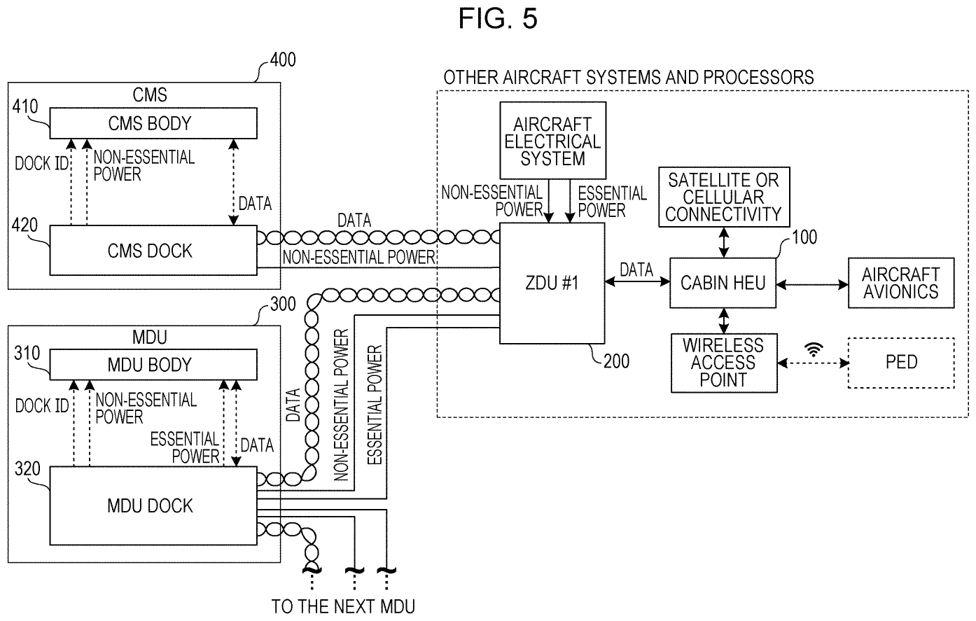

FIG. 3 shows a schematic view of the aircraft cabin system 1000 according to one or more embodiments. FIG. 4 shows a diagram of an overall architecture of the aircraft cabin system 1000 according to one or more embodiments. FIG. 5 shows a block diagram of the aircraft cabin system 1000 according to one or more embodiments. As shown in FIGS. 3 to 5, the aircraft cabin system 1000 comprises: a cabin head end unit (HEU) 100; cabin zone distribution units (ZDUs) 200; MDUs 300; and cabin management system (CMS) terminal 400. In one or more embodiments, the CMS terminal 400 may be a type of MDU having different functions and size.

As illustrated in FIG. 5, the cabin HEU 100 is connected to a wireless access point (WAP), which is installed in the aircraft cabin and enables wireless communication such as Wi-Fi. In some embodiments, the cabin HEU 100 may also connect to the Internet and receive radio waves transmitted from a satellite via an antenna (not illustrated) installed, e.g., on an airframe.

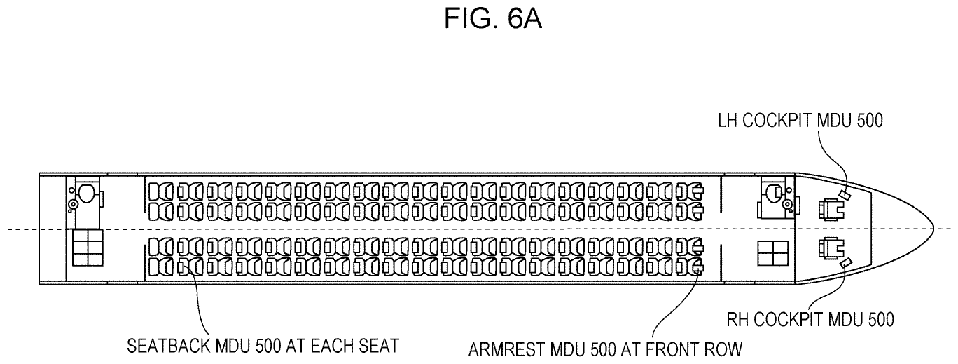

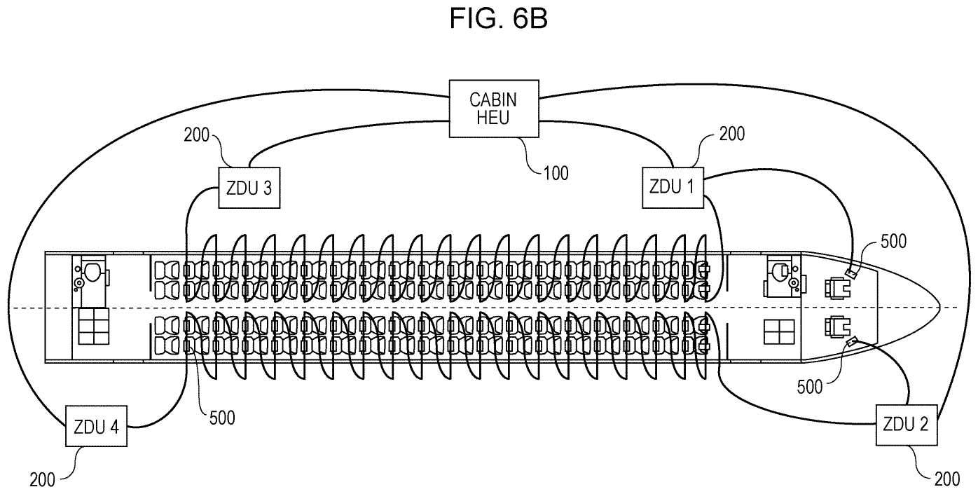

In one or more embodiments, various types or models of MDUs (including the MDUs 300, CMS terminal 400, and other MDU variants including MDUs 500) may be used in the aircraft cabin. The MDUs 300, the CMS terminal 400, and other MDU variants may have different sizes and functions, and may be installed at different locations from one another. For example, in one or more embodiments, the CMS terminal 400 may be installed at a cabin station as illustrated in FIG. 3, while the MDUs 500 may be installed in a right (RH) cockpit, left (LH) cockpit, and seatbacks as illustrated in FIG. 6A. Further, in one or more embodiments, the CMS terminal 400 may be larger than the MDUs 300 and the MDUs 500, while each of the MDUs 300 may be smaller than the CMS terminal 400 as well as the MDUs 500. Other variations in size, location, and function among the MDUs are possible without deviating from the scope of the invention.

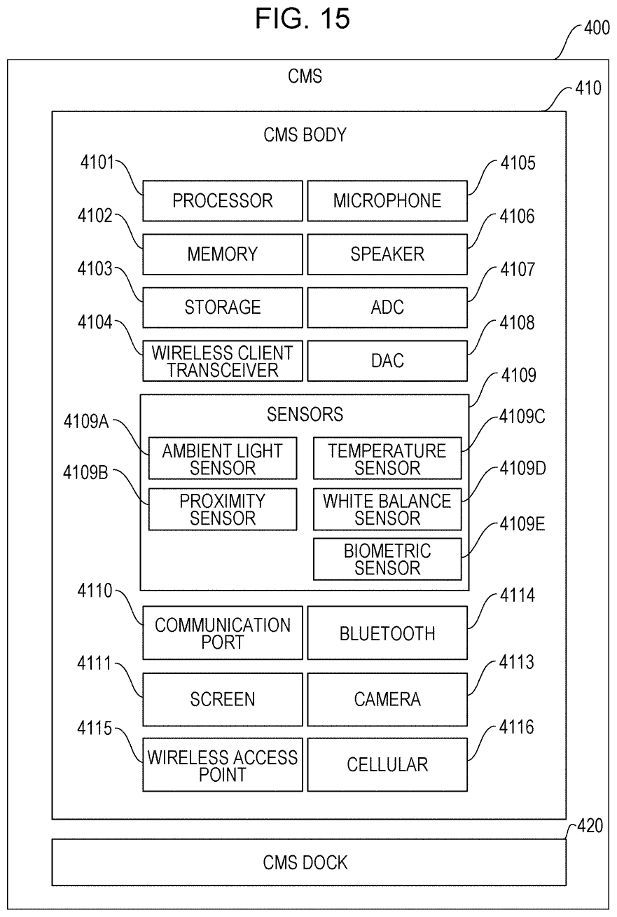

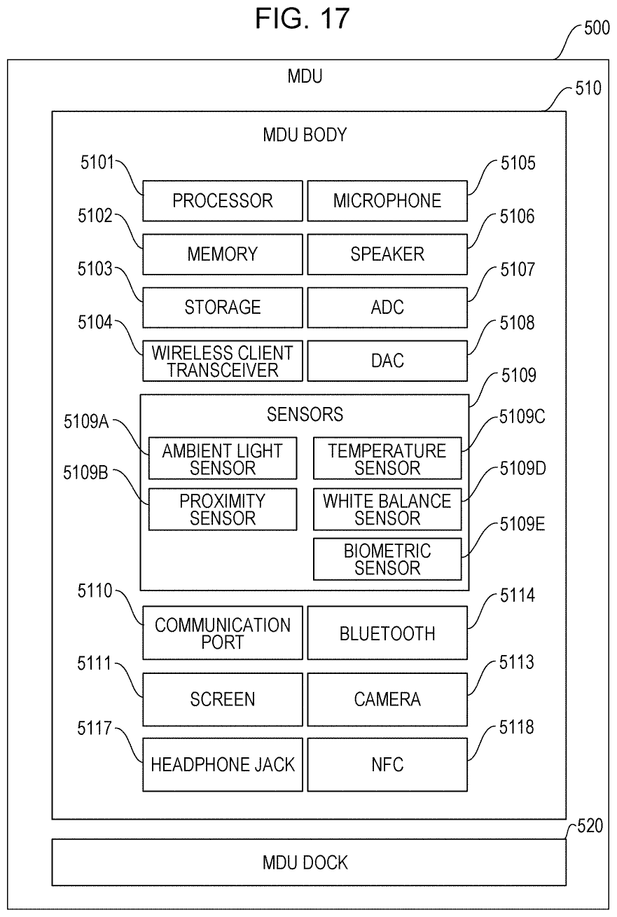

As illustrated in FIG. 5, the cabin HEU 100, cabin ZDUs 200, MDUs 300, and CMS terminal 400 are electrically connected to one another. In one or more embodiments, the MDUs 300 may be replaced with the MDUs 500 in FIG. 5. Each of the MDUs 300 comprises an MDU body (modular display body) 310 and MDU dock (modular display dock) 320. Similarly, the CMS terminal 400 comprises a CMS body 410 and CMS dock 420 as described later with reference to FIG. 15. Each of the MDUs 500 may comprise an MDU body (modular display body) 510 and MDU dock (modular display dock) 520 as described later with reference to FIG. 17.

Turning back to FIG. 5, in one or more embodiments, the MDUs 300, the CMS terminal 400, and cabin ZDUs 200 may communicate with each other through various means, e.g., with twisted pair Ethernet using multipath routing compliant with IEEE 802.1aq and Ethernet over twisted pair compliant with IEEE 802.3bp, IEEE 802.3bw and/or IEEE 802.3ch standards. Other variations in the type of databus (e.g., RS485, CAN, ARINC 664, etc.) are possible without deviating from the scope of the invention. In one or more embodiments, one or more power lines (e.g., essential power and non-essential power) may be applied separately to the MDUs 300, the CMS terminal 400, and the MDUs 500. In other embodiments, the power may be applied to the MDUs 300, CMS terminal 400, and the MDUs 500 using the data lines.

As shown in FIG. 3, the MDUs 300 are installed: between two passenger seats; at front (FWD) and rear (AFT) entrance areas; and at front (FWD) and rear (AFT) lavatories. In this example, the cabin is divided into four zones: front left (FWD LH); front right (FWD RH); rear left (AFT LH); and rear right (AFT RH) zones. One cabin ZDU 200 per zone receives the data and software applications from the cabin HEU 100. Then, the four cabin ZDUs 200 distribute them to the MDUs 300 at the front and the back in the right and left rows, respectively, directly or via the MDUs 300 installed at the FWD and AFT entrance areas and lavatories. The MDUs 300 in each row may be electrically connected via a single data bus. The number of seats, the number of cabin ZDUs 200, and the manner in which the cabin is divided are not limited to these illustrated embodiments. As shown in FIGS. 3 to 5, the CMS terminal 400 is connected separately to the ZDU 200.

As shown in FIG. 6B, in one or more embodiments, the MDUs 500 are installed in seatbacks of passenger seats; in the armrests or on the bulkheads (not shown in the figure) for the front row of passenger seats; and on the left (LH) and on the right (RH) side of the cockpit. In this example, the cabin is divided into four zones: front left (FWD LH); front right (FWD RH); rear left (AFT LH); and rear right (AFT RH) zones. One cabin ZDU 200 per zone receives the data and software applications from the cabin HEU 100. Then, the four cabin ZDUs 200 distribute them to the MDUs 500 at the front and the back in the right and left rows, respectively. The MDUs 500 in each row may be electrically connected via a single data bus. The number of seats, the number of cabin ZDUs 200, the manner in which the cabin is divided, the number of MDUs 500, and the method they are connected are not limited to these illustrated embodiments.

[Cabin Head End Unit (HEU)]

Next, a cabin HEU 100 according to one or more embodiments will be described. The cabin HEU 100 is a server of the cabin system 1000.

In one or more embodiments, the cabin HEU 100 comprises a modular cabinet with Line Replaceable Modules (LRMs), which may be a circuit card or daughter board loaded with various electrical and electronic components to execute a control, sensing, and/or a recording function. The cabinet may comprise a plurality of dedicated slots into which the LRMs are inserted, respectively.

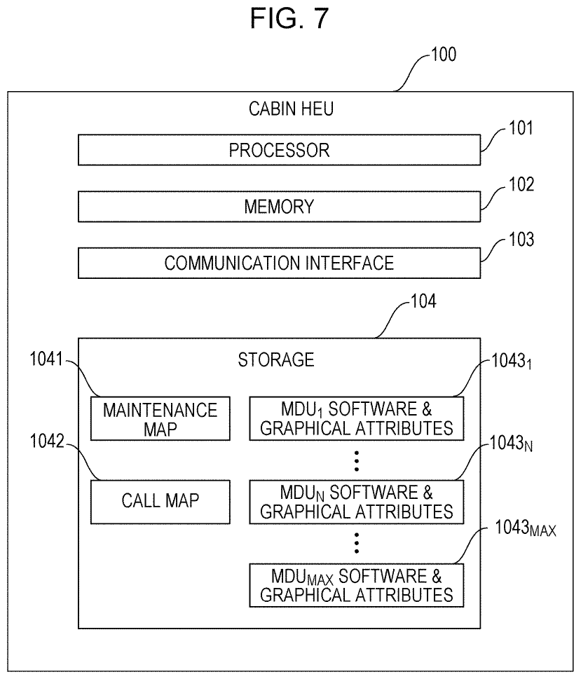

FIG. 7 shows a block diagram of functional components of the cabin HEU 100 according to one or more embodiments. The cabin HEU 100 comprises a processor 101, a memory 102, a communication interface 103, and a storage 104. In one or more embodiments, the storage 104 comprises, among other information, a maintenance map 1041, a call map 1042, and software applications and graphical attributes 1043_{N} corresponding to the installed MDUs 300, respectively. In a case where the MDUs 500 are installed in the cabin, the storage 104 stores the software applications and graphical attributes 1043_{N} corresponding to the installed MDUs 500, respectively.

In one or more embodiments, the processor 101 works in conjunction with the memory 102 and communicates with all the other elements of the network through the communication interface 103; henceforth, processor 101 implies all three: processor 101, memory 102 and communication interface 103.

The software applications and graphical attributes 1043_{N} allow users to control the functions of the MDUs 300 and/or the MDUs 500 and to view indications and contents specific to the locations of the MDUs 300 and/or the MDUs 500 when powered on. In one or more embodiments, the maintenance map 1041 indicates the arrangement of the MDUs 300 and/or the MDUs 500 installed in the cabin. On the maintenance map 1041, a location of the MDU(s) 300 and/or the MDU(s) 500 requiring maintenance can be specified among the installed MDUs 300 and/or the MDUs 500. In one or more embodiments, the call map 1042 indicates the arrangement of the MDUs 300 and/or the MDUs 500 installed in the cabin. On the call map 1042, a location of the MDU(s) 300 and/or the MDU(s) 500 calling a flight attendant can be specified among the installed MDUs 300 and/or the MDUs 500.

In one or more embodiments, in response to a request from the MDUs 300_{N} or the MDUs 500_{N}, the processor 101 transmits from the storage 104 the configuration data that comprises software applications and graphical attributes 1043_{N} relevant to the dock ID of the respective MDU 300_{N} or the MDUs 500_{N}. The MDUs 300_{N} or the MDUs 500_{N} would request such configuration data when newly installed at a certain location.

In one or more embodiments, the software applications for the MDUs 300 and/or the MDUs 500 include at least a first application for performing user controllable functions, and a second application for performing user non-controllable functions. The user controllable functions include reading lights, flight attendant call and reset, etc. that are controllable by passengers and flight attendants. The user non-controllable functions include, among other things, a moving map, a fasten-seat-belt (FSB) or return-to-seat (RTS) sign, a lavatory-occupied (LO) sign, a no-smoking (NS) sign, a cabin interphone call indication, a brightness control, a white balance control, etc. that can merely be displayed/shown on the screen 3111 and/or on the screen 4111 and/or on the screen 5111, but not controlled by passengers or flight attendants.

The processor 101 also monitors the MDUs 300 and/or the MDUs 500 to detect non-responsive MDU(s) 300 and/or MDUs 500 or any internal failure (e.g., broken subparts such as a light, speaker, display, sensors, camera, etc.) in the MDUs 300 and/or the MDUs 500. For example, when the processor 101 does not receive a response signal from the MDU(s) 300 and/or the MDU(s) 500, the processor 101 specifies such MDU(s) 300 and/or MDU(s) 500 as a non-responsive MDU(s). When the processor 101 receives an abnormal signal (i.e., signal indicating the internal failure from the MDU(s) 300 and/or the MDU(s) 500), the processor 101 specifies such MDU(s) 300 and/or MDU(s) 500 as a failed MDU(s). When detecting non-responsive or failed MDU(s) 300 and/or MDU(s) 500, the location of such MDU(s) 300 and/or MDU(s) 500 is shown on the maintenance map 1041 sent by the processor 101 to the CMS terminal 400.

In one or more embodiments, the processor 101 distributes the configuration data to each of the MDUs 300 and/or the MDUs 500 via the cabin ZDUs 200.

[Cabin Zone Distribution Unit (ZDU)]

Next, the cabin ZDUs 200 according to one or more embodiments will be described. The cabin ZDUs 200 function as backbone network switches of the cabin system 1000. As shown in FIGS. 3 to 5 and 6B, the ZDUs 200 provide the communication between the HEU 100 and the MDUs 300, and CMS terminal 400. As described above, the MDUs 300 may be replaced with the MDUs 500 in one or more embodiments. The cabin ZDUs 200 also provide essential and non-essential power to the MDUs 300 or the MDUs 500, as shown in FIG. 5. Through this separate power distribution, essential cabin functions and/or equipment components may be segregated from non-essential cabin functions and/or equipment components to ensure compliance with safety and airworthiness regulations.

[Modular Display Unit (MDU)]

Next, the MDUs 300 according to one or more embodiments will be described. The MDUs 300 are clients of the cabin system 1000. They are flexible and interchangeable equipment components that provide various information and cabin functions to users. In one or more embodiments, the CMS terminal 400 and the MDUs 500 have substantially similar structures as that of the MDU 300 described below.

According to one or more embodiments, each MDU 300 comprises the MDU body 310 and the MDU dock 320. The MDU body 310 may be a lightweight touch screen device that detachably couples to any mating MDU dock 320. For example, although the CMS terminal 400 and/or the MDUs 500 are types of MDUs in one or more embodiments, the MDU body 310 cannot couple to a dock for the CMS terminal 400 or for the MDU 500, because the sizes do not match.

[MDU Body]

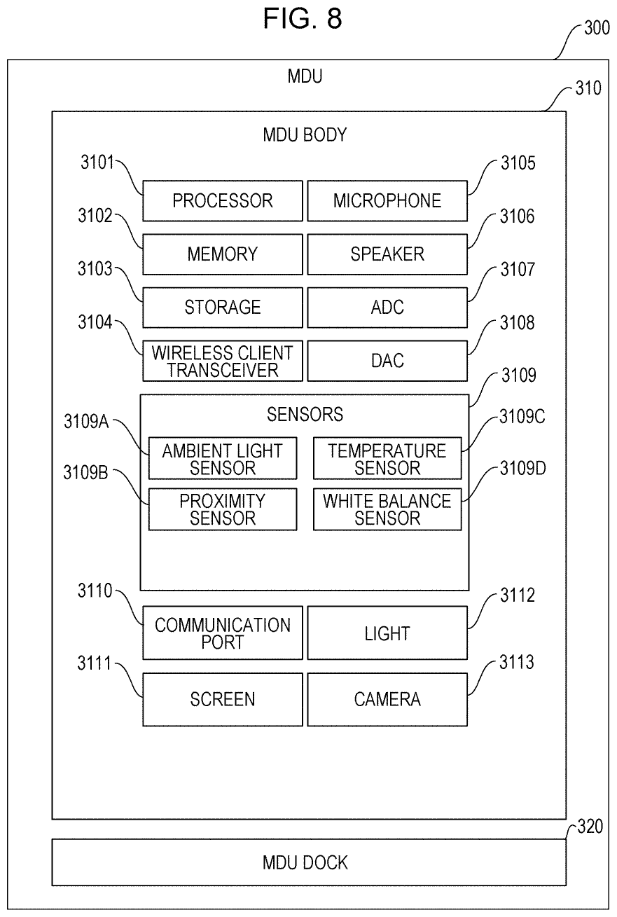

The MDU body 310, according to one or more embodiments, will now be described. FIG. 8 shows a block diagram of functional components of the MDU body 310 according to one or more embodiments. The MDU body 310 comprises: a processor 3101; memory 3102; storage 3103; wireless client transceiver 3104; microphone 3105; speaker 3106; Analog-to-Digital Converter (ADC) 3107; Digital-to-Analog Converter 3108; sensors 3109; communication port 3110; screen 3111; light 3112 such as an LED light; and camera 3113 such as an Ultra High-Definition (UHD) camera. The sensors 3109, the screen 3111, the light 3112, and the camera 3113, according to one or more embodiments, might be powered separately from the rest of the MDU body elements, in order to comply with safety and airworthiness regulations.

The MDU body 310 comprises the processor 3101, which according to one or more embodiments comprises a Central Processing Unit (CPU). When the MDU body 310 is coupled to the mating MDU dock 320 and powered on, the processor 3101 requests the cabin HEU 100 to send the configuration data specific to its location, based upon the MDU dock 320 unique ID strapping. Upon receiving the configuration data, the processor 3101 installs it in the storage 3103, and executes processes and software applications instructed by the configuration data. For example, the processor 3101 retrieves the Graphical User Interface (GUI) from the storage 3103 and displays it on the screen 3111.

The MDU body 310, according to one or more embodiments, comprises a nonvolatile memory 3102 composed of a Random Access Memory (RAM) and a Read Only Memory (ROM). The memory 3102 provides a workspace that temporarily stores data used by the processor 3101.

The MDU body 310, according to one or more embodiments, comprises a storage 3103 that stores the software applications and graphical attributes relevant to the dock ID, which are received from the cabin HEU 100 via the cabin ZDU 200.

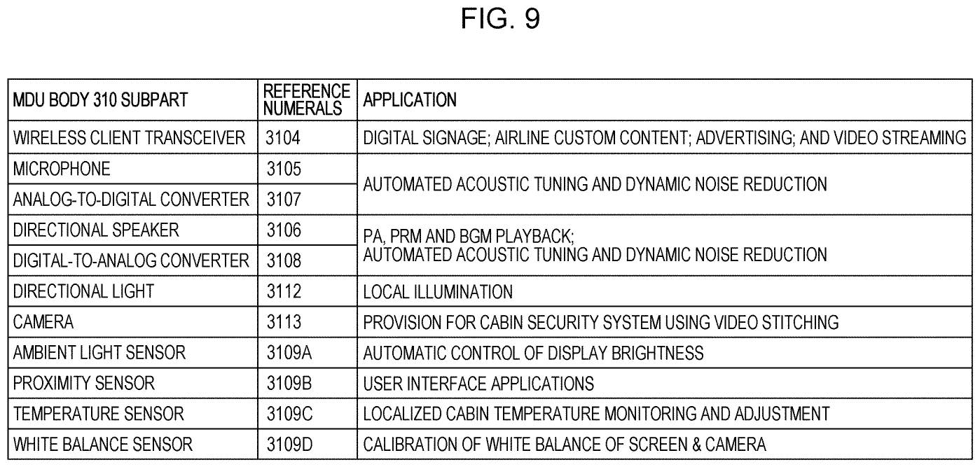

FIG. 9 shows a table illustrating the correspondence between subparts of the MDU body 310 and software applications installable on the MDU body 310 according to one or more embodiments. The software applications include, by way of example, applications for: digital signage display, selection of airline custom content, advertising, and video streaming using the wireless client transceiver 3104; automated acoustic tuning and dynamic noise reduction in the cabin using the microphone 3105 and the ADC 3107; PA, Pre-Recorded Message (PRM), and Background Music (BGM) playback, automated acoustic tuning and dynamic noise reduction in the cabin using a directional speaker 3106 and the DAC 3108; turning on/off and dimming local illumination, e.g., a directional LED light 3112 via an icon or button on the screen 3111; cabin and/or cockpit door surveillance system using face recognition and/or video stitching by the camera 3113 via the CMS terminal 400 (the lens of the camera 3113 may be visibly disabled by default for privacy reason, and may be enabled if specifically requested by an airline); automatically controlling the display brightness of the screen 3111 using an ambient light sensor 3109A; controlling the display on the screen 3111 in response to detection of a proximity of a user's hand to the screen 3111 by a proximity sensor 3109B; monitoring a temperature around the MDU body 310 using a temperature sensor 3109C; and calibrating a white balance of the screen 3111 and/or the camera 3113 based on ambient light using a white balance sensor 3109D.

Turning back to FIG. 8, the MDU body 310, according to one or more embodiments, comprises the wireless client transceiver 3104 that wirelessly receives/transmits signals from/to remote units/devices/terminals in the cabin system 1000. In one or more embodiments, the wireless client transceiver 3104 may connect to the Internet.

The MDU body 310, according to one or more embodiments, comprises: the microphone 3105 and the ADC 3107. The microphone 3105 detects the ambient sound in the aircraft cabin and converts it to an electrical sound signal that is sent to the ADC 3107. The ADC 3107 converts the electrical sound signal to digital sound signals such as Ethernet digital signals.

The MDU body 310, according to one or more embodiments, comprises the speaker 3106 and the DAC 3108. The DAC 3108 converts the digital sound signals to analog sound signals. The speaker 3106 outputs sound based on the analog signals converted by the DAC 3108.

In one or more embodiments, an authorized user may perform an automated acoustic tuning for the cabin speakers as described in U.S. patent application Ser. No. 16/503,028, filed Jul. 3, 2019, incorporated herein in its entirety.

In one or more embodiments, the cabin HEU 100 may perform dynamic noise reduction in the cabin as described in U.S. patent application Ser. No. 16/503,103, filed Jul. 3, 2019, incorporated herein in its entirety.

The MDU body 310 comprises the sensors 3109, which according to one or more embodiments, comprises: (1) an ambient light sensor 3109A that detects ambient light around the MDU body 310 so that the processor 3101 can automatically control display brightness of the screen 3111 in response to a detected signal transmitted from the ambient light sensor; (2) a proximity sensor 3109B that detects a user's hand and its proximity to the screen 3111 so that the processor 3101 can control the display on the screen 3111 in response to a detected signal transmitted from the proximity sensor (e.g., GUI icon(s) gets bigger as the hand approaches the screen 3111); (3) a temperature sensor 3109C that monitors a temperature around the MDU body 310 so that the processor 3101 can transmit temperature information to the cabin HEU 100; and (4) a white balance sensor that senses a color temperature so that the processor 3101 can calibrate the white balance of the screen 3111 and/or the camera 3113.

The MDU body 310 comprises a communication port 3110 which, according to one or more embodiments, is a power and data communication port connected with the network of the cabin system 1000. The communication port 3110 enables the MDU body 310 to communicate via the ZDU 200 with the HEU 100.

The MDU body 310 comprises a screen 3111, which according to one or more embodiments, is a multi-touch screen device. The screen 3111 displays user controllable and non-controllable functions in response to commands from the sensors 3109, from the HEU 100, and in response to users touching the icons appearing on the screen 3111 such as switching the reading light ON and OFF and calling the flight attendant.

The MDU 300 comprises a MDU dock 320 which, according to one or more embodiments, is hardwired to the cabin system backbone network and to the ZDU 200 power. The MDU dock 320 provides to the MDU body 310 the specific ID for the installed location. In one or more embodiments, the MDU dock 320 provides also a network switch function.

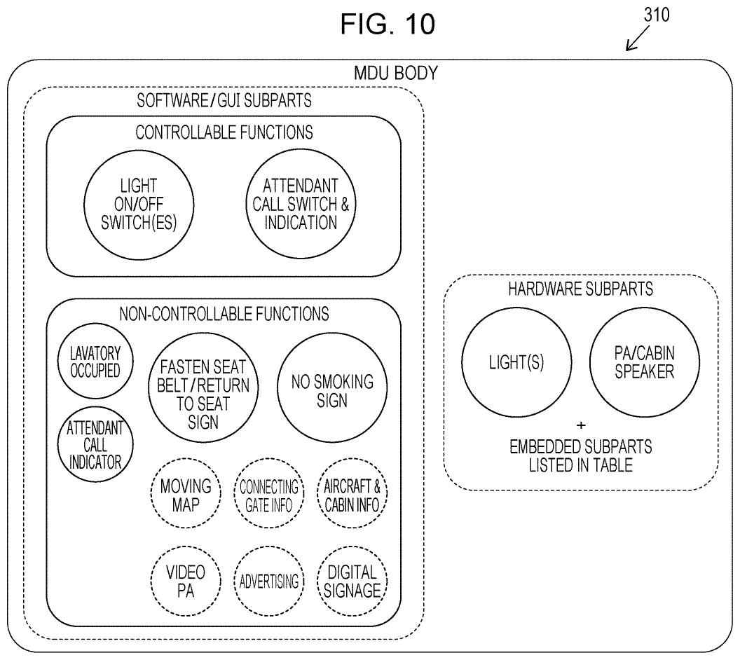

FIG. 10 shows a diagram illustrating a GUI with icons appearing on the screen 3111 corresponding to the software applications installed on the MDU body 310 according to one or more embodiments.

The icons are grouped into two categories: (i) icons of user controllable functions and (ii) icons of user non-controllable functions.

The user controllable functions include, e.g., turning on/off the reading light 3112, and calling a flight attendant by touching a flight attendant call icon on the screen 3111. The user controllable functions also include, e.g., resetting an active call from a passenger. In one or more embodiments, if a passenger touches the flight attendant call icon on the screen 3111, the processor 3101 sends a calling signal to the cabin HEU 100 and displays the attendant call icon on the screen 3111. The cabin HEU 100 receives the signal and sends to the CMS terminal 400 the call map 1042 together with the location of the MDU 300 that initiated the call so that the screen 4111 of the CMS terminal 400 displays them. The flight attendant can reset the call map on the CMS terminal 400 and the attendant call indicator on the MDU 300 via the CMS terminal 400 or directly from the MDU 300.

The user non-controllable functions include, e.g., displaying an FSB or RTS sign, an LO sign, and a NS sign, on the screen 3111. Some MDUs 300 such as those installed in the entrance areas have, as the user non-controllable function, the attendant call indicators that allow a flight attendant to identify a type of interphone call (e.g., normal or emergency), a caller (e.g., a passenger, a flight deck crew, etc.), and a status of the call (e.g., ringing). The user non-controllable functions also include, e.g., allowing a passenger to view and/or hear information such as a moving map, connecting gate information, aircraft and cabin information (e.g., passenger address (PA) announcements from the flight attendants or from the flight deck crew), PA video streaming, advertising, and digital signage, via the speaker 3106 and/or the screen 3111. Although not illustrated in FIG. 10, the user non-controllable functions also include controlling the subparts of the MDU body 310 in response to a detected signal from the sensors 3109, as described above.

[MDU Dock]

Next, the MDU dock 320 according to one or more embodiments will be described. According to one or more embodiments, the MDU docks 320 are hardwired to the network of the cabin system 1000. Each of the MDU docks 320 comprises a wired communication port to which the communication port 3110 of any of the compatible MDU bodies 310 can be electrically connected. In one or more embodiments, the MDU dock 320 might comprise an ethernet switch (not shown) with three ports, one connected to the communication port 3110 and the other two connected to the MDU dock 320 of the previous MDU 300, and to the MDU dock 320 of the following MDU 300. In one or more embodiments, the ethernet switch in the MDU dock 320 is powered and functional even if the MDU body 310 is failed or missing from the MDU dock 320. In one or more embodiments, this ethernet switch may comply with the IEEE 802.1aq or any other standard related to multi-routing.

Each of the MDU docks 320 contains a unique ID, which identifies each of the MDU docks 320 on the network. The dock IDs correspond to locations at which the MDU docks 320 are installed in the aircraft cabin. To each of the dock IDs, a specific set of software applications and graphical attributes is assigned by the cabin HEU 100 via the ZDUs 200.

When the MDU body 310 is coupled to any of the MDU docks 320, on boot-up, the MDU body 310 requests, to the cabin HEU 100, the applicable functionality and GUI assets for that location based on the dock ID of the mating MDU dock 320. The dock IDs may be implemented either via hardware (i.e., hardwired into a connector of the MDU dock 320) or by software.

The MDU body 310 is an interchangeable device that can mate with any of the compatible MDU docks 320 in the aircraft cabin and can perform the functions specific to the installed location of the mating MDU dock 320.

According to this structure, the MDUs 300 can advantageously be functionally configured for multiple purposes and at multiple locations in the aircraft cabin. The MDUs 300 (the MDU bodies 310 and the MDU docks 320) of the same hardware can be used at any of different locations to provide different functionality depending on the location at which the MDU 300 is installed.

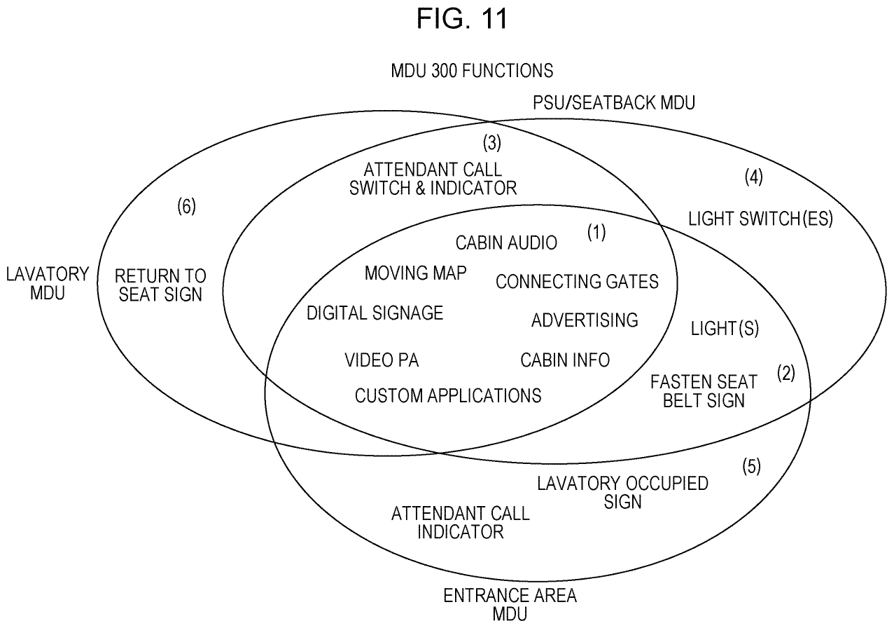

Turning now to FIG. 11, a diagram is shown explaining a conceptual scheme of common and different functions of the MDUs 300 at different locations within the aircraft cabin according to one or more embodiments. These include, by way of example: (1) functions common to all the MDUs 300 (Cabin audio, Moving Map, Connecting Gates, Digital Signage, Advertising, Video PA, Cabin information, and Custom Applications); (2) functions common to the MDUs 300 installed between two passenger seats and at the entrance areas (Light(s) and Fasten Seat Belt Sign); (3) functions common to the MDUs 300 installed between two passenger seats and at the lavatories (Attendant Call Switch & Indicator); (4) functions unique to the MDUs 300 installed between two passenger seats or at the seatback of passenger seats (Light Switches); (5) functions unique to the MDUs 300 at the entrance areas (Attendant Call Indicator and Lavatory Occupied Sign); and (6) functions unique to the MDUs 300 at the lavatories (Return to Seat Sign).

[Locking/Unlocking Mechanisms of MDU]

Next, locking/unlocking mechanisms of the MDU 300 according to one or more embodiments will be described. In one or more embodiments, the CMS terminal 400 and the MDUs 500 may have the same or substantially similar locking/unlocking mechanisms as those of the MDU 300 described below. Each of the MDUs 300 incorporates a locking/unlocking mechanism in the hardware design, which allows the MDU body 310 to easily couple/decouple to/from the MDU dock 320. In the locked state, the MDU body 310 electrically connects to the MDU dock 320. The mechanism ensures that in the event of a MDU body failure, removal and replacement of the MDU body 310 from the MDU dock 320 does not impact or impede any other component installation in the aircraft.

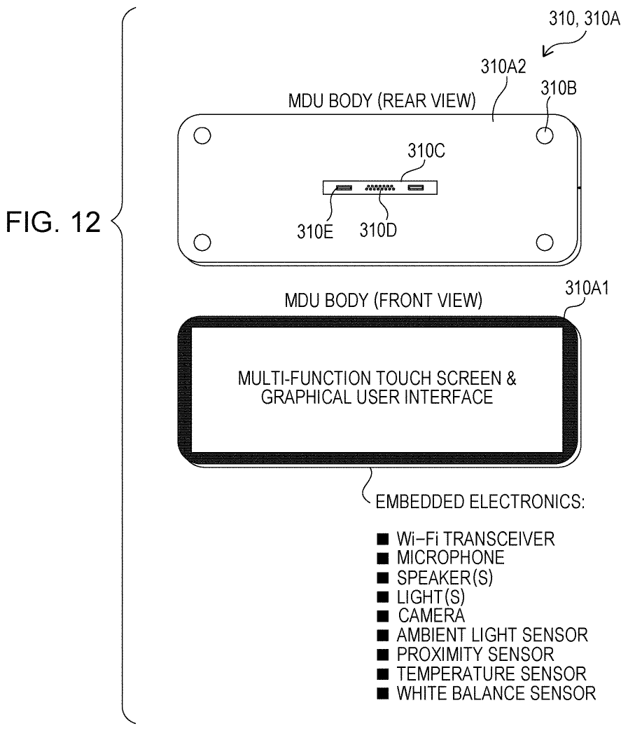

FIG. 12 shows the MDU body 310 according to one or more embodiments. The MDU body 310 comprises a casing 310A comprising a front surface 310A1 and a rear surface 310A2. Near four corners of the rear surface 310A2, four magnetic points 310B are disposed. In the center of the rear surface 310A2, a female connector 310C is disposed, where contact pads 310D and two guide openings 310E are formed.

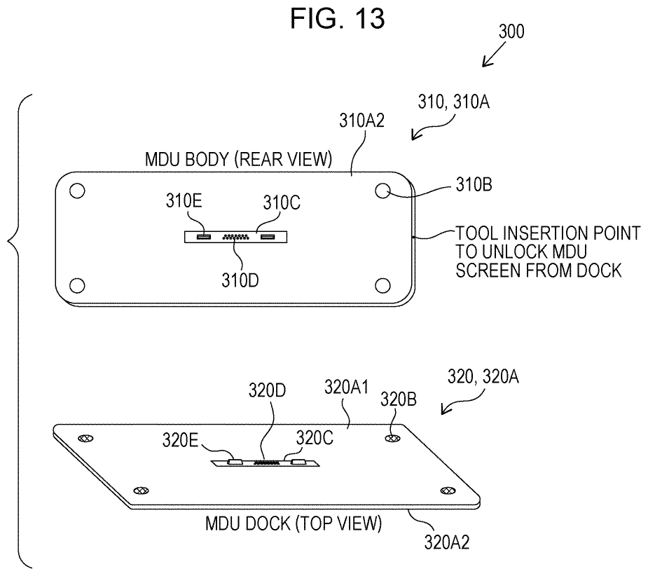

FIG. 13 shows the MDU body 310 together with an MDU dock 320 according to one or more embodiments. As shown in FIG. 13, the MDU dock 320 comprises a base 320A comprising a front surface 320A1 and a rear surface 320A2. Near the four corners of the front surface 320A1, four connection points 320B are disposed to be a dock magnet coupling with the corresponding magnetic points 310B. In the center of the front surface 320A1, a male connector 320C is disposed to be a docked part with the female connector 310C. In the male connector 320C, pogo pins 320D corresponding to the contact pads 310D, and two guide tabs 320E corresponding to the two guide openings 310E are formed. The MDU body 310 and the MDU dock 320 are electrically connected to each other via the pogo pins 320D and the contact pads 310D in the locked state.

The numbers and positions of the magnetic points 310B and the connection points 320B, the female connector 310C and the male connector 320C, the contact pads 310D and the pogo pins 320D, and the guide openings 310E and the guide tubs 320E are not limited to the embodiments illustrated in FIG. 13.

The dock magnet coupling between the magnetic points 310B and the connection points 320B allows an easy “snap-in” installation of the MDU body 310 into the MDU dock 320.

The docked part between the female connector 310C and the male connector 320C ensures accurate contact between the MDU body 310 and the MDU dock 320. Proper alignment of the female connector 310C and the male connector 320C is ensured by the two guiding tabs 320E, which also functions as locking tabs.

In a state where the MDU body 310 is snapped-in and latched to the MDU dock 320, an electromechanical mechanism locks the MDU body 310 automatically in place. The processor 101 of the cabin HEU 100 sends a command to release the electromechanical lock to the MDU dock 320. When releasing the electromechanical lock, the HEU processor 101 also sends to the screen 4111 of the CMS terminal 400, via the ZDU 200, the maintenance map 1041 and location of the unlocked state of the MDU(s) 300. If no power is available on the aircraft, a maintenance personnel can perform mechanical release using a special tool. The mechanical release is performed by inserting the tool into the MDU body 310 or into the MDU dock 320, for example, at the point shown in FIG. 13.

According to the aforementioned structure, advantageously, the MDU body 310 can be easily aligned and latched to the MDU dock 320. In one or more embodiments, the MDU body 310 can be further fixed by another means, such as screws or quarter-turn fasteners, to prevent from coming off from the MDU dock 320, especially when the aircraft vibrates.

In one or more embodiments, the MDU body 310 is hot-swappable, i.e., can be replaced while the aircraft cabin system 1000 is powered on/running. Specifically, the pins of the male connector 320C are changed in length so that some pins are connected before other pins are connected and disconnected after the other pins are disconnected. This structure enables the MDU body 310 to be added and/or removed from the MDU dock 320 without stopping or shutting down any system in the aircraft cabin.

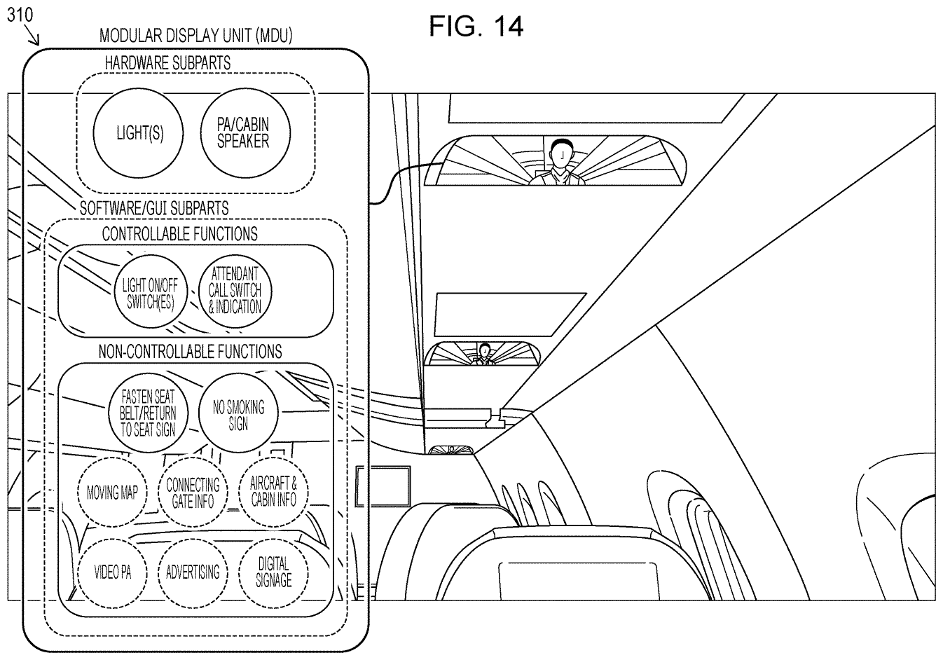

Turning next to FIG. 14, a diagram is shown illustrating another example of functions and GUI of the MDUs, 300, according to one or more embodiments.

In one or more embodiments, the MDUs 300 each have a roughly trapezoidal shape, and are attached above the passenger seats in the PSU, respectively, as illustrated in FIG. 14. Also the user controllable functions and the user non-controllable functions are shown.

[Cabin Management System (CMS) Terminal]

Next, the CMS terminal 400 according to one or more embodiments will be described. In one or more embodiments, the CMS terminal 400 is installed at the cabin station to perform CMS functions for flight attendants.

FIG. 15 shows a block diagram of functional components of the CMS terminal 400, according to one or more embodiments. The CMS terminal 400 (which may be a type of MDU) comprises: a CMS body 410, comprising a processor 4101; memory 4102; storage 4103; wireless client transceiver 4104; microphone 4105; speaker 4106; ADC 4107; DAC 4108; sensors 4109, communication port 4110; screen 4111; and camera 4113 such as an Ultra High-Definition (UHD) camera. Almost all the blocks of the CMS terminal 400 have similar structures and functions to those of the MDU 300 shown in FIG. 8, however the CMS terminal 400 may not have lights. The CMS terminal 400 has specific blocks such as Bluetooth radio 4114; wireless access point 4115; and cellular module 4116 (which may be, e.g., a 5G cellular module).

When MDU(s) 300 and/or MDU(s) 500 is (are) non-responsive or failed, the cabin HEU 100 identifies the MDU(s) 300 and/or MDU(s) 500 by the specific ID(s) and sends, to the CMS terminal 400 via the ZDU 200, the maintenance map 1041 indicating the location of the identified MDU(s) 300 and/or MDU(s) 500, so that flight attendants can confirm it on the screen 4111 of the CMS terminal 400. When receiving the information, the processor 4101 commands the screen 4111 to display the non-responsive or failed MDU(s) 300 and/or MDU(s) 500 in a different way from the remaining MDUs 300 and/or MDUs 500, for example, by making such MDU(s) 300 and/or MDU(s) 500 flashing or blinking, on the maintenance map 1041 received from the cabin HEU 100. After such MDU(s) 300 and/or MDU(s) 500 is (are) noticed by the flight attendants, maintenance personnel is requested to come to the aircraft and perform maintenance on the detected non-responsive or failed MDU(s) 300 and/or MDU(s) 500.

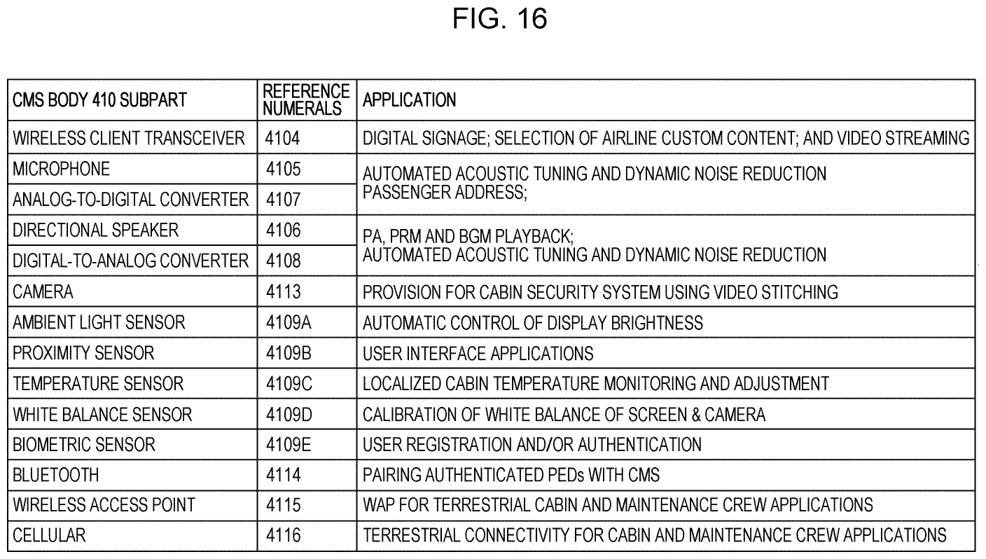

FIG. 16 shows a table illustrating the correspondence between subparts of the CMS body 410 and software applications installable on the CMS body 410, according to one or more embodiments. The software applications include, by way of example, applications for: digital signage display, selection of airline custom content, and video streaming using the wireless client transceiver 4104; automated acoustic tuning and dynamic noise reduction in the cabin, and PA using the microphone 4105 and the ADC 4107; PA, PRM, and BGM playback, automated acoustic tuning and dynamic noise reduction in the cabin using a directional speaker 4106 and the DAC 4108; cabin and/or cockpit door surveillance system using face recognition and/or video stitching by the camera 4113; automatically controlling the display brightness of the screen 4111 using the ambient light sensor 4109A; controlling the display on the screen 4111 in response to detection of a proximity of a user's hand to the screen 4111 by a proximity sensor 4109B; monitoring a temperature around the CMS body 410 using a temperature sensor 4109C; calibrating a white balance of the screen 4111 and/or the camera 4113 based on ambient light using a white balance sensor 4109D; granting access to the CMS functions only to registered and authenticated users using a biometric sensor 4109E; pairing authenticated Portable Electronic Devices (PEDs) with the CMS terminal 400 using the Bluetooth radio 4114; and communicating with the ground Wi-Fi and/or cellular networks (which may be, e.g., a 5G cellular) for cabin and maintenance crew applications using the wireless access point 4115 and the 5G cellular module 4116.

Turning back to FIG. 15, the CMS body 410, according to one or more embodiments, comprises the wireless client transceiver 4104 that wirelessly receives/transmits signals from/to remote units/devices/terminals in the cabin system 1000. In one or more embodiments, the wireless client transceiver 4104 may connect to the Internet.

The CMS body 410 comprises the sensors 4109, which according to one or more embodiments comprises: (1) an ambient light sensor 4109A that detects ambient light around the CMS body 410 so that the processor 4101 can automatically control display brightness of the screen 4111 in response to a detected signal transmitted from the ambient light sensor 4109A; (2) a proximity sensor 4109B that detects a user's hand and its proximity to the screen 4111 so that the processor 4101 can control the display on the screen 4111 in response to a detected signal transmitted from the proximity sensor 4109B (e.g., GUI icon(s) gets bigger as the hand approaches the screen 4111); (3) a temperature sensor 4109C that monitors a temperature around the CMS body 410 so that the processor 4101 can transmit temperature information to the cabin HEU 100; (4) a white balance sensor 4109D that senses a color temperature so that the processor 4101 can calibrate the white balance of the screen 4111 and/or the camera 4113; and (5) a biometric sensor 4109E which allows users to register and authenticate on the CMS.

The CMS body 410 comprises the Bluetooth radio 4114, which according to one or more embodiments, is a communication port allowing the PEDs of the registered and authenticated users to pair with the CMS.

The CMS body 410 comprises the wireless access point 4115 and the 5G cellular 4116, which according to one or more embodiments, provides terrestrial connectivity for the cabin and maintenance crew. In one or more embodiments, the wireless access point 4115 is used during all phases of flight and allows registered and authenticated users' PEDs and wearables to connect to the CMS.

The CMS 400 comprises a CMS dock 420, which according to one or more embodiments, is hardwired to the cabin system backbone network and to the ZDU 200 power. The CMS dock 420 provides to the CMS body 410 the specific ID for the installed location. In one or more embodiments, the CMS dock 420 provides also a network switch function.

[Other MDU Variants]

Next, other MDU variants including the MDU 500 according to one or more embodiments will be described. As described above, other MDU variants may have different sizes and functions, and may be installed at different locations from the MDUs 300. In one or more embodiments, the MDU 500 may be installed in the LH and RH cockpit and at each seatback location, as well as in the armrests (not shown), or integrated with the tray-tables (not shown) or installed on the bulkhead (not shown) for the users in the front row seats (refer to FIG. 6B).

FIG. 17 shows a block diagram of functional components of the MDU 500 according to one or more embodiments. The MDU 500 comprises a MDU body 510 that comprises: a processor 5101; memory 5102; storage 5103; wireless client transceiver 5104; microphone 5105; speaker 5106; ADC 5107; DAC 5108; sensors 5109, communication port 5110; screen 5111; and camera 5113 such as an Ultra High-Definition (UHD) camera. Almost all blocks of the MDU body 510 have similar structures and functions to those of the MDU 300 shown in FIG. 8, however the MDU 500 may not have lights. The MDU 500 has specific blocks such as Bluetooth radio 5114; headphone jack 5117; and near-field communication (NFC) module 5118.

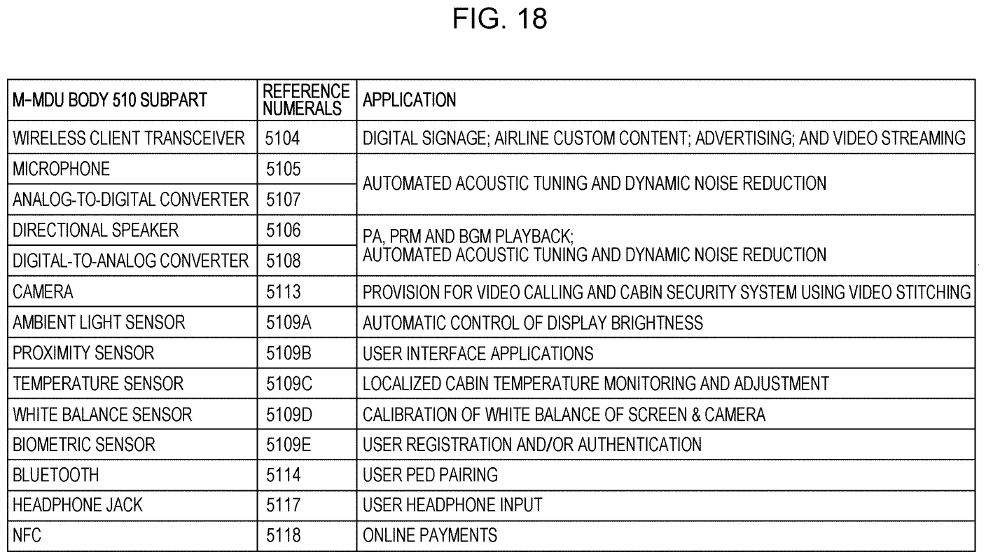

FIG. 18 shows a table illustrating the correspondence between subparts of the MDU body 510 and software applications installable on the MDU body 510 according to one or more embodiments. The software applications include, by way of example, applications for: digital signage display, selection of airline custom content, advertising, and video streaming using a wireless client transceiver 5104; smart cabin audio tuning and real-time dynamic cabin noise reduction using the microphone 5105 and the ADC 5107; PA, PRM, and BGM playback, smart cabin audio tuning, and real-time dynamic noise reduction using a directional speaker 5106 and the DAC 5108; cabin and/or cockpit door surveillance system using face recognition and/or video stitching by the camera 5113; automatically controlling the display brightness of the screen 5111 using the ambient light sensor 5109A; controlling the display on the screen 5111 in response to detection of a proximity of a user's hand to the screen 5111 by a proximity sensor 5109B; monitoring a temperature around the MDU body 510 using a temperature sensor 5109C; calibrating a white balance of the screen 5111 and/or the camera 5113 based on ambient light using a white balance sensor 5109D; granting access to specific MDU 500 functions only to registered and authenticated users using a biometric sensor 5109E; pairing authenticated PEDs with the MDU 500 using the Bluetooth radio 5114; providing users with the capabilities to use wired headsets connected to the headphone jack 5117; and near field communication using the NFC module 5118.

Turning back to FIG. 17, MDU body 510, according to one or more embodiments, comprises the wireless client transceiver 5104 that wirelessly receives/transmits signals from/to remote units/devices/terminals in the cabin system 1000. In one or more embodiments, the wireless client transceiver 5104 may connect to the Internet.

The MDU body 510 comprises the sensors 5109, which according to one or more embodiments comprises: (1) an ambient light sensor 5109A that detects ambient light around the MDU body 510 so that the processor 5101 can automatically control display brightness of the screen 5111 in response to a detected signal transmitted from the ambient light sensor 5109A; (2) a proximity sensor 5109B that detects a user's hand and its proximity to the screen 5111 so that the processor 5101 can control the display on the screen 5111 in response to a detected signal transmitted from the proximity sensor 5109B (e.g., GUI icon(s) gets bigger as the hand approaches the screen 5111); (3) a temperature sensor 5109C that monitors a temperature around the MDU body 510 so that the processor 5101 can transmit temperature information to the cabin HEU 100; (4) a white balance sensor 5109D that senses a color temperature so that the processor 5101 can calibrate the white balance of the screen 5111 and/or the camera 5113; and (5) a biometric sensor 5109E which allows users to register and authenticate on the MDU body 510.

The MDU body 510 comprises a Bluetooth radio 5114, which according to one or more embodiments, is a communication port allowing the registered and authenticated users to pair their PEDs with the MDU body 510.

The MDU 500 comprises an MDU dock 520, which according to one or more embodiments, is hardwired to the cabin system backbone network and to the ZDU 200 power. The MDU dock 520 provides to the MDU body 510 the specific ID for the installed location. In one or more embodiments, the MDU dock 520 provides also a network switch function.

[Management and Control of MDU]

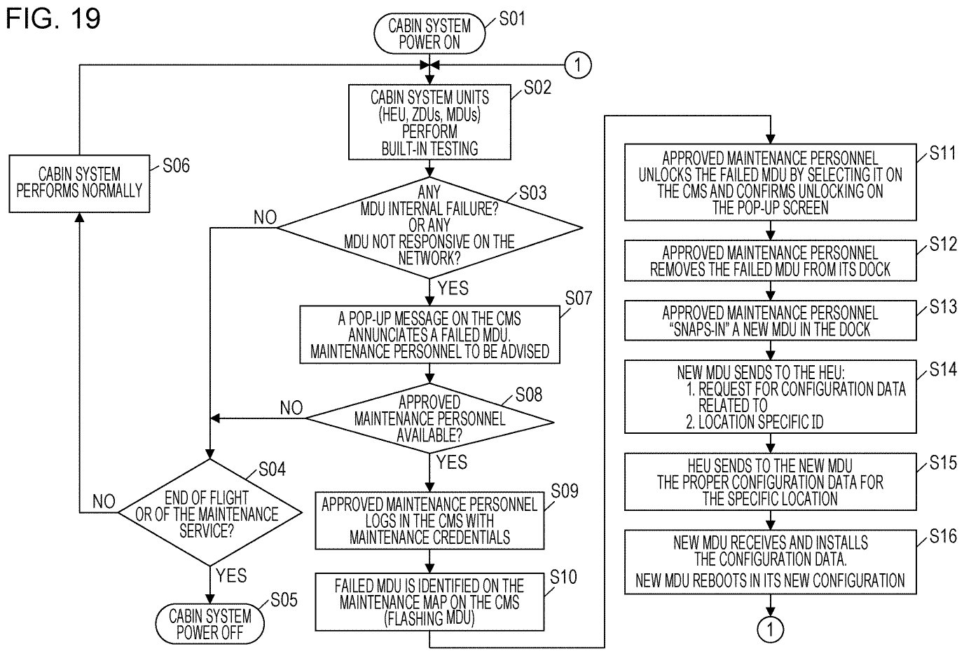

Next, an example of the management and control of the MDUs 300 will be described with reference to FIG. 19, which shows a flowchart of management and control processing of the MDUs 300 according to one or more embodiments. In one or more embodiments, the MDUs 500 may be added to the cabin system 1000, and managed and controlled similarly to the MDUs 300.

As shown in FIG. 19, once the ICS of the aircraft is powered on (Step S01), the cabin HEU 100, ZDUs 200, and MDUs 300 perform periodic built-in testing (Step S02). The processor 101 of the cabin HEU 100 continuously monitors the MDUs 300 to detect a non-responsive/failed MDU(s) 300.

If the processor 101 of the cabin HEU 100 detects no failure (Step S03: No), the ICS continues to operate until the end of flight or the start of the maintenance service. When the flight or the maintenance service ends (Step S04: Yes), the ICS is powered off (Step S05). Otherwise (Step S04: No), the ICS continues to operate normally (Step S06), and the process returns to Step S02.

If the processor 101 of the cabin HEU 100 detects a non-responsive/failed MDU(s) 300 (Step S03: Yes), the processor 101 of the cabin HEU 100 retrieves from the cabin HEU storage 104 the maintenance map 1041 and sends it to the CMS terminal 400 together with the ID(s) of the non-responsive/failed MDU(s) 300. The CMS terminal 400 displays a pop-up message annunciating the non-responsive/failed MDU(s) 300 on the screen 4111 (Step S07). The personnel who sees the pop-up message is instructed to advise the maintenance personnel about the failed MDU(s) 300. In one or more embodiments, the pop-up message also annunciates the source of the failure and possible remedies.

If an approved maintenance personnel is not available (Step S08: No), the ICS continues to operate until the end of the flight or of the maintenance service, and the process proceeds to Step S04.

If an approved maintenance personnel is available (Step S08: Yes), the approved maintenance personnel logs in the CMS terminal 400 with maintenance credentials (Step S09).

The CMS terminal 400 indicates, on the screen 4111, the non-responsive/failed MDU(s) 300, by flashing its location, on the maintenance map (Step S10).

When the approved maintenance personnel selects the failed MDU(s) 300 on the maintenance map by touching the screen 4111, the processor 101 of the cabin HEU 100 releases the electromechanical lock between the MDU body 310 and the MDU dock 320 (Step S11). When the processor 101 releases the electromechanical lock and the CMS terminal 400 indicates the unlocked state of the non-responsive/failed MDU(s) 300 on the screen 4111, the approved maintenance personnel has to confirm the unlocked state and then go to the location at which the MDU(s) 300 is installed.

At the next step (Step S12), the approved maintenance personnel removes, from the MDU dock 320, the MDU(s) body 310 of the non-responsive/failed MDU(s) 300. Even if there is no failure, the approved maintenance personnel can replace any MDU body 310 from the MDU dock 320, by selecting the respective MDU body 310 on the maintenance map 1041 displayed on the CMS terminal screen 4111 and following the steps above.

During the maintenance of the MDU body 310, a replacement MDU body 310 is coupled to the MDU dock 320. The approved maintenance personnel can easily perform alignment and latch, and then fixation, as the MDU body 310 is snapped-into the MDU dock 320 (Step S13).

Then, the replacement MDU body 310 sends, to the cabin HEU 100, (1) the dock ID specific to the location and (2) the request for the configuration data related to that location (Step S14).

When receiving the dock ID and the request from the replacement MDU body 310, the cabin HEU 100 sends the configuration data to the replacement MDU body 310 (Step S15).

Upon receiving the configuration data, the replacement MDU body 310 installs the configuration data, and reboots in the installed file (Step S16). Thus, the ICS becomes free of failures, and the process returns to Step S02. The cabin power can be turned off if the maintenance service has been terminated (Step S03: No, Step S04: Yes, Step S05).

As shown, the aircraft cabin system 1000, according to one or more embodiments, operations are more centralized and more coordinated due to the user controllable and user non-controllable functions consolidated in the MDU body 310. This eliminates the fragmentation of conventional PSU components while maintaining the existing feature set. According one or more embodiments, a maintenance personnel can service any of the components without removing a whole supporting structure (such as the PSU, passenger seat, ceiling panel, and lavatory side panel).

Moreover, aircraft OEMs benefit from the following improvements, according to one or more embodiments of the invention: the integration of multiple hardware components into one unit reduces the parts count typically required for aircraft cabin systems; overall system weight is reduced; and the overall volume required for installation and wiring is reduced.

The aircraft cabin system 1000, according to one or more embodiments, utilizes a single data bus to carry power and data to the MDUs in each row, thereby simplifying the wiring and reducing the number of components. This decreases installation time and points of failure, and increases system reliability.

The MDU is easily configurable, allowing it to be used for multiple purposes and in multiple locations in the aircraft cabin. The modularity and flexibility of the MDU reduces maintenance time and cost for airlines. The MDU may be applied to any location in the aircraft cabin requiring one or a plurality of the aforementiond functions.

Although the disclosure has been described with respect to only a limited number of embodiments, those skilled in the art, having benefit of this disclosure, will appreciate that various other embodiments may be devised without departing from the scope. Accordingly, the scope of the invention should be limited only by the attached claims.

What is claimed is:

1. An aircraft cabin system comprising:
a cabin server that stores an application and a graphical attribute; and
a plurality of modular displays connected to the cabin server via a network, wherein
each of the modular displays comprises:
a modular display dock hardwired to the network; and
a modular display body that is detachably attached and electrically connected to the modular display dock,
the modular display body comprises:
a touch screen that displays a GUI; and
a processor,
the processor sends, to the cabin server, a request for the application and the graphical attribute when the modular display body is coupled to the modular display dock,
the cabin server sends, to the modular display body via the modular display dock, the application and the graphical attribute in response to the request, and
upon receiving the application and the graphical attribute, the processor performs a user controllable function in response to an operation of the touch screen, and performs a user non-controllable function via the modular display body, according to the application and the graphical attribute.

2. The aircraft cabin system according to claim 1, wherein
the modular display body comprises a reading light, and
the user controllable function is to turn on, dim, or turn off the reading light.

3. The aircraft cabin system according to claim 1, wherein
the touch screen comprises a flight attendant call icon, and
the user controllable function is to send a calling signal to the cabin server in response to an operation of the flight attendant call icon.

4. The aircraft cabin system according to claim 1, wherein
the user non-controllable function is to display, on the touch screen, at least one of a fasten-seat-belt sign or return-to-seat sign, lavatory-occupied sign, no-smoking sign, and cabin interphone call indication.

5. The aircraft cabin system according to claim 1, wherein
the modular display body comprises a wireless transceiver, and
the user non-controllable function is to display, on the touch screen, information received via the wireless transceiver, the information including digital signage, airline custom content, advertising, and video streaming.

6. The aircraft cabin system according to claim 1, wherein
the modular display body comprises an ambient light sensor, and
the user non-controllable function is to control display brightness of the touch screen in response to a detected signal transmitted from the ambient light sensor.

7. The aircraft cabin system according to claim 1, wherein
the modular display body comprises a proximity sensor, and
the user non-controllable function is to control the display on the touch screen in response to detection of a proximity of a hand to the touch screen by the proximity sensor.

8. The aircraft cabin system according to claim 1, wherein
the modular display body comprises a white balance sensor, wherein
the user non-controllable function is to calibrate a white balance of the touch screen in response to a detected signal transmitted from the white balance sensor.

9. The aircraft cabin system according to claim 1, wherein
the modular display body comprises a speaker, wherein
the user non-controllable function is to output passenger address (PA) audio via the speaker.

10. The aircraft cabin system according to claim 1, further comprising:
a cabin management system (CMS) terminal that comprises a touch screen, wherein
the cabin server stores a dock ID unique to an installed location of the modular display dock,
the cabin server monitors the modular displays and detects a non-responsive or failed modular display in the network, and
upon detecting the non-responsive or failed modular display, the cabin server sends, to the CMS terminal, locational information of the detected modular display based on the dock ID.

11. The aircraft cabin system according to claim 10, wherein
upon receiving the locational information, the CMS terminal indicates, on the touch screen of the CMS terminal, the non-responsive or failed modular display in a different way from the remaining modular displays on a maintenance map.

12. The aircraft cabin system according to claim 1, wherein
the modular display body is latched to the modular display dock by magnet coupling, and the latched modular display is locked to the modular display dock by an electromechanical lock.

13. The aircraft cabin system according to claim 1, wherein
the modular display body is hot-swappable.
